(19) United States
(12) Patent Application Publication
(10) Pub. No.: US 2011/0175378 A1
(43) Pub. Date: Jul. 21, 2011

(54) ADJUSTABLE DOOR STRIKE FOR LATCH AND DEADBOLT

(75) Inventor: Levent Gosterisli, Norcross, GA (US)

(73) Assignee: UTC FIRE & SECURITY CORPORATION, Farmington, CT (US)

(21) Appl. No.: 13/119,843

(22) PCT Filed: Sep. 19, 2008
(86) PCT No.: PCT/US2008/010901

§ 371 Date: Mar. 18, 2011

(51) Int. Cl. E05B 15/02; B23P 11/00

(52) U.S. Cl. 292/341.19; 29/525.11; 292/341.18

(57) ABSTRACT

An adjustable door strike includes a mounting bracket (10) and an adjustable strike (12) mounted to a doorframe (26) that allows for the position of the strike (12) to be adjusted such that it is aligned with latch and/or deadbolt mounted on a door. The mounting bracket (10) includes a first mounting aperture (14(a), a second mounting aperture (14b) and a rectangular opening (16) located between the first mounting aperture (14a) and the second mounting aperture (14b). The adjustable strike (12) includes a first slotted aperture (18a) located on a first edge of the adjustable strike (12), a second slotted aperture (18b) located on a second edge opposite the first edge of the adjustable strike (12), and a latch opening (22). The adjustable strike (12) is secured between a doorframe (26) and the mounting bracket (10) by a first screw (28a) mounted through the first mounting aperture (14a), through the first slotted aperture (18a) and into the doorframe (26) and by a second screw (28b) mounted through the second mounting aperture (14b), through the second slotted aperture (18b) and into the doorframe (26). The position of the adjustable strike (12) can be adjusted in the region defined by the first and second slotted apertures (18a, 18b). Having positioned the adjustable strike (12) to align with a latch and/or deadbolt, the screws (28a, 28b) are tightened, thereby clamping the adjustable strike (12) between the doorframe (26) and the mounting bracket (10).

### BACKGROUND

The present invention is related to door latch systems, and in particular to an adjustable door strike that can be adjustably positioned along a doorframe to accept a latch and/or deadbolt.

One of the most difficult and time consuming tasks associated with installing a door lock is aligning the latch (mounted on the door) with the door strike (mounted on the door frame). Misalignment between the latch and the door strike prevents the door from being latched and locked.

In many applications, once the latch has been positioned on the door, it is difficult if not impossible to re-position. Likewise, many doorframes come with prefabricated slots for mounting the door strike, making it difficult to adjust the position of the door strike. If there is misalignment between the door strike and the latch, the installer is typically required to machine or file a portion of the strike to accept the latch. The installation can therefore be time-intensive, expensive, and visually unappealing.

### SUMMARY

An adjustable door strike system for mounting onto a doorframe allows the position of the door strike to be adjusted during installation without having to re-drill holes. The system includes a mounting bracket and an adjustable strike. The mounting bracket includes a first mounting aperture, a second mounting aperture and a rectangular opening located between the first mounting aperture and the second mounting aperture. The adjustable strike includes a first slotted aperture located on a first edge of the adjustable strike, a second slotted aperture located on a second edge opposite the first edge of the adjustable strike, and a latch opening. The adjustable strike is secured between a doorframe and the mounting bracket by a first screw mounted through the first mounting aperture, through the first slotted aperture and into the doorframe and by a second screw mounted through the second mounting aperture, through the second slotted aperture and into the doorframe. The position of the adjustable strike can be adjusted in the region defined by the first and second slotted apertures. Having positioned the adjustable strike to align with a latch and/or deadbolt, the screws are tightened, thereby clamping and securing the adjustable strike between the doorframe and the mounting bracket.

### BRIEF DESCRIPTION OF THE DRAWINGS

FIG. 1 is an isometric view of a mounting bracket and a adjustable strike according to an embodiment of the present invention.

FIG. 2 is an exploded isometric view of the mounting bracket and adjustable strike positioned for mounting on a doorframe jam.

FIG. 3 is an isometric view of a mounting bracket and a adjustable strike according to another embodiment of the present invention.

FIG. 4 is an exploded isometric view of the mounting bracket and adjustable strike (as shown in FIG. 3) positioned for mounting on a doorframe jam.

### DETAILED DESCRIPTION

The present invention provides an adjustable strike mounting system that allows for positional adjustment of the adjustable strike. In particular, the design provides a solution that is straight forward to install, maintain, and provides a degree of physical security not available in most adjustable door strike systems.

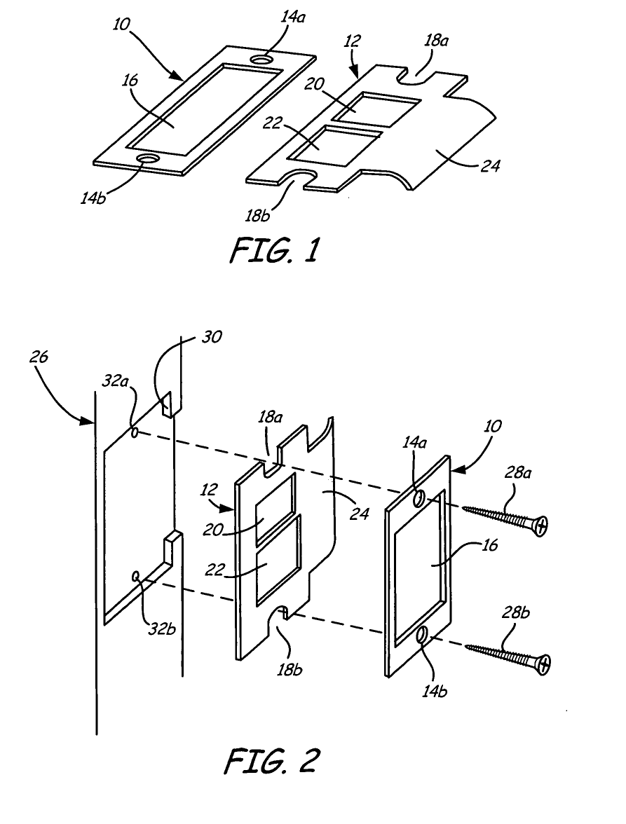

FIG. 1 is an isometric view of mounting bracket 10 and adjustable strike 12 according to an embodiment of the present invention. Mounting bracket 10 includes mounting apertures 14a and 14b, and rectangular opening 16. Adjustable strike 12 includes slotted apertures 18a and 18b, deadbolt opening 20, latch opening 22, and tongue 24.

FIG. 2 is an exploded isometric view that illustrates the positioning of mounting bracket 10 and adjustable strike 12 for installation onto doorframe 26. Adjustable strike 12 is positioned between mounting bracket 10 and doorframe 26. Mounting bracket 10 is secured to doorframe 26 by screws 28a and 28b, which are fed through slotted apertures 18a and 18b, respectively, in mounting bracket 10 and then through mounting apertures 14a and 14b, respectively, on adjustable strike 12.

In an exemplary embodiment, the adjustable mounting system is employed in a doorframe having pre-fabricated cavity 30 and pre-drilled holes 32a and 32b. In the prior art, a door strike is formed to fit within pre-fabricated cavity 30, but without a mechanism by which the position of the door strike could be modified. The present invention overcomes this problem by dividing the typical door strike into two portions, mounting bracket 10 and adjustable strike 12.

In an exemplary embodiment, the length of mounting bracket 10 is approximately equal to the length of cavity 30, allowing mounting bracket 10 to fit securely within cavity 30. Likewise, pre-drilled holes 32a and 32b are positioned to be aligned with mounting apertures 14a and 14b. Thus, the position of mounting bracket 10 cannot be adjusted. However, the position of latch opening 22 and deadbolt opening 20 (and thus alignment between the latch and latch opening as well as deadbolt and deadbolt opening) is determined by the position of adjustable strike 12, which is designed to be adjustable. In particular, adjustable strike 12 is sized to be slightly smaller than cavity 30. In an exemplary embodiment, adjustable strike 12 has a length that is less than the length of cavity 30, allowing the position of adjustable strike 12 to be adjusted in the vertical direction within cavity 30.

In addition, instead of mounting apertures (as used on mounting bracket 10), adjustable strike 12 employs slotted apertures 18a and 18b which are greater in size than mounting apertures 14a and 14b. In particular, slotted apertures 18a and 18b may be larger in the vertical direction than mounting apertures 14a and 14b, allowing the position of adjustable strike to be adjusted in the vertical direction within the space allowed by the slotted apertures. For example, if adjustable strike 12 is positioned such that screws 28a and 28b are located in the middle of slotted apertures 18a and 18b, but adjustable strike 12 is too low for proper alignment, then adjustable strike 12 can be adjusted upward by an amount defined by the bottom of slotted aperture 18a. Likewise, adjustable strike 12 can be adjusted downward by an amount defined by the top of slotted aperture 18b.

In another exemplary embodiment, the width of adjustable strike 12 as well as the width of slotted apertures 18a and 18b (as compared with mounting apertures 14a and 14b) are sized to allow for horizontal adjustment of adjustable strike 12. The necessity for vertical adjustments is more common, but horizontal adjustment may also be beneficial.

The present invention is particularly useful in applications in which cavity 30 and pre-drilled holes 32a and 32b are formed prior to installation of the doorframe, because the pre-fabricated door will not allow for adjustment of the location of mounting bracket. However, the present invention may be employed in applications in which an installer defines the location of cavity 30 and pre-drilled holes 32a and 32b.

Thus, during installation an installer positions adjustable strike 12 within cavity 30. Mounting bracket 10 is placed over the top of adjustable strike 12, also within cavity 30, and screws 28a and 28b are threaded through mounting apertures 14a and 14b, respectively, through slotted apertures 18a and 18b, respectively, and into pre-drilled holes 32a and 32b, respectively, of doorframe 26. Before tightening screws 28a and 28b, an installer checks the alignment between the latch assembly (not shown) and latch opening 22 (this may also include checking alignment between a deadbolt assembly, not shown, and deadbolt opening 20). If the alignment is correct, then screws 28a and 28b are tightened to clamp adjustable strike 12 between mounting bracket 10 and doorframe 26, thereby holding adjustable strike 12 in the desired position. If the alignment is not correct, then the installer adjusts the vertical and/or horizontal position of adjustable strike 12 within the limits defined by slotted apertures 18a and 18b before tightening screws 28a and 28b. A benefit of the embodiment described with respect to FIGS. 1 and 2 is the presence of tongue 24 on adjustable strike 12, which provides a convenient way for an installer to re-position adjustable strike 12.

A benefit of the adjustable strike described with respect to FIGS. 1 and 2 is both mounting bracket 10 and adjustable strike 12 are secured by screws 28a and 28b to doorframe 26, providing an adjustable system that is also secure. In prior art systems, the adjustable strike is often affixed (either by screws or other means) only to a mounting bracket, resulting in an adjustable strike system that is only as secure as the screws mounted into the mounting bracket, not into the doorframe itself.

In addition to improving the installation and security of adjustable strike mounting systems, the present invention also improves maintenance associated with adjustable strike systems. For instance, often buildings settle after being built, resulting in mis-alignment between adjustable strike 12 and the latch and/or deadbolt. Typically, this would require filing the adjustable strike itself, or re-drilling holes in the doorframe to move the position of the adjustable strike. The present invention allows the position of adjustable strike 12, and in particular the position of deadbolt opening 20 and latch opening 22, to be adjusted without having to re-drill holes in doorframe 26. Rather, screws 28a and 28b are loosened, allowing an installer to reposition adjustable strike 12 either in the horizontal or vertical direction depending on the mis-alignment, and then secure adjustable strike 12 in the desired position by re-tightening screws 28a and 28b

Another advantage of the embodiment of the present invention described with respect to FIGS. 1 and 2 is the presence of both deadbolt opening 20 and latch opening 22. This avoids requiring an installer to individually position both a deadbolt mount and a latch mount onto doorframe 26, further reducing the installation time.

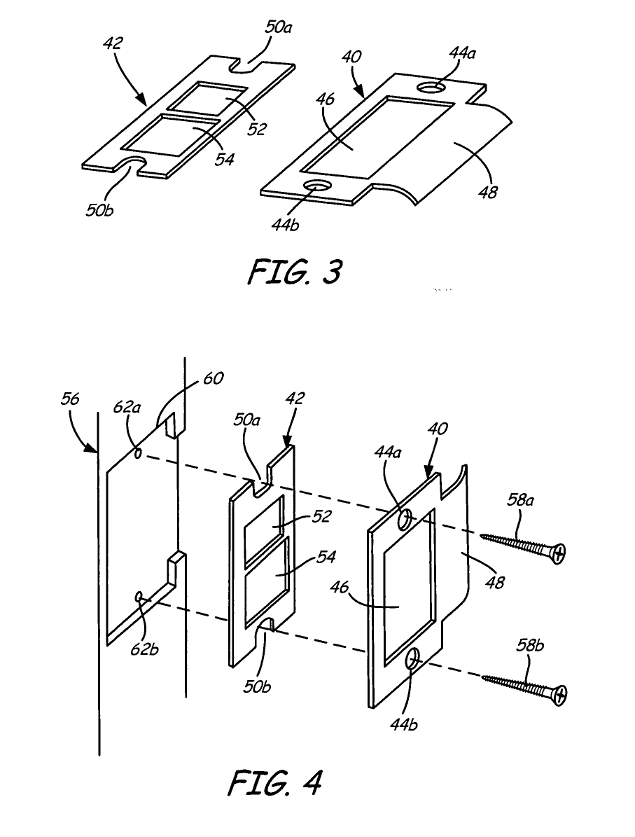

FIG. 3 is an isometric view of mounting bracket 40 and adjustable strike 42. Mounting bracket 40 includes mounting apertures 44a and 44b, rectangular opening 46, and tongue 48. Adjustable strike 42 includes slotted apertures 50a and 50b, deadbolt opening 52, and latch opening 54. In contrast with the embodiment shown in FIGS. 1 and 2, mounting bracket 40 includes tongue 48 and adjustable strike 42 includes deadbolt opening 52 and latch opening 54. A benefit of this design is it is reversible (i.e., it may be mounted on either side of a doorframe). Mounting bracket 40 may be mounted on, for instance, a right side of a doorframe in the current orientation, or may be flipped end-for-end and mounted on the left side of a doorframe.

FIG. 4 is an exploded isometric view that illustrates the positioning of mounting bracket 40 and adjustable strike 42 for installation onto doorframe 56. For installation, mounting bracket 40 is positioned over the top of adjustable strike 42, wherein adjustable strike 42 is positioned against doorframe 56. Mounting bracket 40 and adjustable strike 42 are secured to doorframe 56 by screws 58a and 58b which pass through mounting apertures 44a and 44b, respectively, slotted apertures 50a and 50b, respectively, and into doorframe 56.

Once again, for applications in which doorframe 56 includes a pre-made cavity 60 and pre-drilled holes 62a and 62b, mounting bracket 40 is sized to fit within pre-made cavity 60 while adjustable strike 42 is sized slightly smaller (i.e., shorter length as compared with mounting bracket 40) to allow adjustable strike 42 to be adjusted in the vertical direction within pre-made cavity 60. Adjustable strike 42 may also have shorter width as compared with mounting bracket 40 to allow adjustable strike 42 to be adjusted in the horizontal direction as well. In other embodiments, an installer is required to form cavity 60 and drill holes 62a and 62b during installation. However, the present invention is particularly useful in application in which cavity 60 and holes 62a and 62b are formed prior to installation of the doorframe, because the pre-fabricated door will not allow for adjustment of the location of a typical mounting bracket and door strike.

Having inserted screws 58a and 58b through mounting bracket 40 and adjustable strike 42, but before tightening the screws, an installer can adjust the position of adjustable strike 42. The amount of adjustment provided by adjustable strike 42 is dependent on the size of slotted apertures 50a and 50b. Each slotted aperture 50a and 50b is once again larger than mounting apertures 44a and 44b. In an exemplary embodiment, slotted apertures 50a and 50b are elongated in the vertical direction, allowing the position of adjustable strike 42 to be adjusted in the vertical direction. In this embodiment, the length of adjustable strike 42 is less than the length of mounting bracket 40, allowing adjustable strike 42 to be adjusted in the vertical direction within cavity 60. The size of slotted apertures 50a and 50b, as well as the length of adjustable strike 42 determines the amount of vertical adjustment available. In another exemplary embodiment, slotted apertures 50a and 50b are elongated (with respect to mounting apertures 44a and 44b) in the horizontal direction as well, allowing adjustable strike 42 to be adjusted in both the horizontal and vertical directions.

Having positioned adjustable strike 42 in the desired location, an installer tightens screws 58a and 58b, clamping adjustable strike 42 between doorframe 56 and mounting bracket 40. Adjustable strike 42 is properly positioned when the latch (not shown) and deadbolt (not shown), both of which are secured to the door, are properly aligned with latch opening 54a and deadbolt opening 52.

Benefits of mounting bracket 40 and adjustable strike 42 once again extend to both the installation, security and maintenance of door lock system. Following installation, if the latch or deadbolt assembly becomes mis-aligned with latch opening 54 and deadbolt opening 52, respectively, an installer can loosen screws 58a and 58b and adjust the vertical and/or horizontal position of adjustable strike 42. Following the re-alignment, screws 58a and 58b are re-tightened through holes 62a and 62b such that mounting bracket 40 and adjustable strike 42 are once again secured in place. Once again, the embodiment of adjustable strike 42 shown in FIGS. 3 and 4 includes latch opening 54 and deadbolt opening 52, thereby preventing an installer from having to align and mount both a deadbolt mount and a latch mount onto doorframe 56, further reducing the installation time.

Although the present invention has been described with reference to preferred embodiments, workers skilled in the art will recognize that changes may be made in form and detail without departing from the spirit and scope of the invention. For example, in both of the embodiments described with respect to FIGS. 1-4, the adjustable strike includes both a latch opening and a deadbolt opening. In other embodiments, the adjustable strike may include only a latch opening or only a deadbolt opening, depending on the application.

1. An adjustable door strike comprising:
a mounting bracket having a first mounting aperture, a second mounting aperture and a rectangular opening located between the first mounting aperture and the second mounting aperture; and
an adjustable strike having a first slotted aperture located on a first edge of the adjustable strike, a second slotted aperture located on a second edge opposite the first edge of the adjustable strike, and a latch opening, wherein the adjustable strike is securable between a doorframe and the mounting bracket by a first screw mounted through the first mounting aperture, through the first slotted aperture and into the doorframe and by a second screw mounted through the second mounting aperture, through the second slotted aperture and into the doorframe, wherein a position of the adjustable strike is adjustable by moving the adjustable strike in a vertical direction as allowed by the first and second slotted apertures and secured in a desired position by tightening the first and second screws to clamp the adjustable strike between the mounting bracket and the doorframe.

2. The adjustable door strike of claim 1, wherein the adjustable strike can be adjusted in the vertical direction a distance defined by a vertical length of the first and second slotted apertures.

3. The adjustable door strike of claim 1, wherein the adjustable strike can be adjusted in a horizontal direction a distance defined by a horizontal length of the first and second slotted apertures.

4. The adjustable door strike of claim 1, wherein the adjustable strike further includes a deadbolt opening positioned adjacent to the latch opening.

5. The adjustable door strike of claim 4, wherein the rectangular opening on the mounting bracket is greater in size than the deadbolt opening and latch opening located on the adjustable strike.

6. The adjustable door strike of claim 1, wherein the adjustable strike further includes a tongue portion extending from a third edge of the adjustable strike located between the first edge and the second edge.

7. The adjustable door strike of claim 1, wherein the mounting bracket further includes a tongue portion extending from an edge of the mounting bracket.

8. A method of installing an adjustable strike assembly, the method comprising:
placing an adjustable strike and a mounting bracket within a cavity formed on a doorframe, wherein the adjustable strike is positioned between the doorframe and the mounting bracket;
adjusting the position of the adjustable strike such that a latch opening on the adjustable strike is aligned with a latch mounted on a door, wherein the position of the adjustable strike can be adjusted in a vertical direction by an amount determined by a length of slotted apertures located on opposite edges of the adjustable strike; and
securing the adjustable strike in a desired position by tightening screws threaded through mounting apertures on the mounting bracket, through the slotted apertures on the adjustable strike and into the doorframe, wherein the adjustable strike is clamped in place between the mounting bracket and the doorframe.

9. The method of claim 8, wherein adjusting the position of the adjustable strike such that a latch opening on the adjustable strike is aligned with a latch mounted on a door includes adjusting the position of the adjustable strike such that a deadbolt opening on the adjustable strike is aligned with a deadbolt mounted on the door.

10. The method of claim 8, wherein adjusting the position of the adjustable strike includes adjusting the position of the adjustable strike in a horizontal direction by an amount determined by a width of the slotted apertures located on the opposite edges of the adjustable strike.

11. An adjustable strike assembly comprising:
a doorframe having a cavity defined along an edge of the doorframe and a first and second hole drilled within the cavity;
an adjustable strike adjustably positioned within the cavity and having a first slotted aperture, a second slotted aperture, and a latch opening, wherein the adjustable strike is positioned such that the latch opening is aligned with a latch assembly mounted on a door;
a mounting bracket having a first mounting aperture, a second mounting aperture, and a rectangular opening;
a first screw threaded through the first mounting aperture, the first slotted aperture and into the first drilled hole located within the cavity; and
a second screw threaded through the second mounting aperture, the second slotted aperture and into the second drilled hole located within the cavity, wherein the first screw and the second screw cause the adjustable strike to be clamped in a desired position between the mounting bracket and the doorframe, wherein the adjustable strike can be adjustably positioned within a range defined by the size of the first and second slotted apertures.

12. The adjustable strike assembly of claim 11, wherein the first slotted aperture and the second slotted aperture have a vertical length that is greater than a diameter of the first and mounting apertures, allowing the adjustable strike to be adjustably positioned in the vertical direction prior to tightening of the first and second screws.

13. The adjustable strike assembly of claim 11, wherein the first slotted aperture and the second slotted aperture have a horizontal width that is greater than a diameter of the first and mounting apertures, allowing the adjustable strike to be adjustably positioned in the horizontal direction prior to tightening of the first and second screws.

14. The adjustable strike assembly of claim 11, wherein the adjustable strike includes a deadbolt opening, wherein the adjustable strike is adjustably positioned such that the deadbolt opening is aligned with a deadbolt assembly mounted on a door.
